(19) United States
(12) Patent Application Publication
(10) Pub. No.: US 2002/0199018 A1
(43) Pub. Date: Dec. 26, 2002

(54) Maping physical locations to web sites

(75) Inventors: Richard Alan Diedrich, Rochester, MN (US); Mahdad Majd, Rochester, MN (US); John Matthew Santosuosso, Rochester, MN (US)

Correspondence Address: Gero G. McClellan, Thomason, Moser & Patterson, L.L.P., Suite 1500, 3040 Post Oak Boulevard, Houston, TX, 77056-6582, US

(73) Assignee: International Business Machines Corporation, Armonk, NY (US)

(21) Appl. No.: 09/886,324

(22) Filed: Jun. 21, 2001

(51) Int. Cl. G06F 15/16

(52) U.S. Cl. 709/245; 709/219

(57) ABSTRACT

Methods, systems and articles of manufacture for searching network information by geographic region. A geographic region may be defined as the metes and bounds of a plot of land, a location identified by a physical address, a particular structure, a global positioning system (GPS) address, etc. In each case, a geographic region is associated with a network address, such as a uniform resource locator (URL). The association between the network address and the region may be embodied in a data structure. An application then uses the data structure to resolve a query containing geographic location information indicating a current position of a requesting device.

### BACKGROUND OF THE INVENTION

1. Field of the Invention

The present invention generally relates to data processing. More particularly, embodiments of the invention relate to searching for information on a computer network.

2. Description of the Related Art

Computer networks were developed to allow multiple computers to communicate with each other. In general, a network can include a combination of hardware and software that cooperate to facilitate the desired communications. One example of a computer network is the Internet, a sophisticated worldwide network of computer system resources.

Information on a network, such as the Internet, is located at a network address. One common network addressing format is a Universal Resource Locator (URL). The address may be to a user's own computer, or on another computer networked with the user's computer. In particular, the information at a given address may reside on a networked computer (called a host) with an Internet address. In the case of the World Wide Web (WWW), a logical grouping of electronic documents on a given host is known as a website.

The growing size of networks, particularly the Internet, makes it difficult to locate relevant information in an expedient fashion. As a result, search tools were developed to locate information on the network based on a query input by a user. Two common search methods include the use of search engines and directories, both having capability to search listings. In the case of search engines, a search tool referred to as a spider, a crawler, or a robot, build indexes containing the traversed addresses according to well-known protocols and algorithms. Directories are compiled in part by human operators. In any case, the results of a query submitted to a search engine or directory are displayed to the user for review and selection.

Regardless of the particular search tool structure, conventional search tools reside on a server accessible to multiple users. Search queries, in the form of search words phrases, keywords, network addresses, etc., are sent from the users to the search tools via a network connection. The search tools then parse the query and execute a search algorithm to identify any network addresses containing information matching the query. In particular, a user-input query prompts the search tool to sift through the plurality of network addresses (typically on the order of millions) in an index to find matches to the user query.

Despite the benefits provided by search tools and uniform resource locators, users still struggle with efficiently locating information on networks. For example, often times a user may have difficulty recalling a URL he/she was provided. As a result, the user is forced to locate the desired information by other means. Most typically, a user will perform a manual search using keywords. However, such an approach is tedious and often produces voluminous results which the user must sift through before locating the URL of interest.

Recent attempts to make Internet information more useful recognize the impact of increasing demands for mobile computing. Users are no longer bound to a fixed geographical location when accessing the Internet (e.g., from a PC at an office or home). Instead, state-of-the-art technology has made mobile computing possible with devices such as wireless personal digital assistants (PDAs), wireless Web-enabled telephones and the like. Such devices are also frequently equipped with GPS units, allowing users to determine their present location.

One effort to exploit the current technology includes utilizing location dependent information to facilitate searches. In particular, one prior art method extracts the address string from a source, converts the address string into coordinates, generates a metatag which represents the relevant location to the source, and then indexes the metatag for searching or mapping.

However, the foregoing method suffers from many deficiencies. One deficiency of conventional methods is their limitation to a particular point, defined by the intersection of a latitudinal coordinate and a longitudinal coordinate. A search, therefore, indiscriminately returns the Web pages of physical locations which are closest to the particular point. This has the sometimes unintended effect of providing the user with superfluous or unwanted network addresses.

A related deficiency of conventional methods is that a location is defined only in two dimensions, latitude and longitude. Some locations, however, are not capable of being defined in two dimensions. Consider, for example, a high-rise building having a plurality of residential and/or commercial units at various levels.

Therefore, there exists a need for searching for and locating location dependent network information which overcomes the deficiencies of the prior art.

### SUMMARY OF THE INVENTION

The present invention generally relates to data processing. More particularly, embodiments of the invention relate to searching for information on a computer network.

One embodiment provides a method of locating network addresses associated with regions according to geographic information. The method comprises receiving a query for a network address associated with a geographic region, wherein the query contains geographic location information indicating a current position of requesting device. Upon parsing the query, geographic region information defining the geographic region and satisfying the query according to the geographic location information is located in a network address locator data structure. The method further comprises returning at least the network address associated with the geographic region.

Another embodiment provides a method of locating network addresses associated with regions according to geographic information. The method comprises receiving a query for a network address associated with a geographic region, wherein the query contains geographic location information indicating a current position of requesting device. Upon parsing the query, the method comprises locating, in a network address locator data structure, geographic region information defining the geographic region and satisfying the query according to the geographic location information. At least the network address associated with the geographic region is then returned to the requesting device.

Still another embodiment provides a method of locating network addresses using geographic location information specifying a current location of a requesting device. The method comprises transmitting a query for a network address associated with a geographic region, wherein the query contains the geographic location information. A response containing at least two network addresses is then received and at least one of the at least two network addresses is discarded. The device then displays the remaining network addresses of the at least two network addresses, wherein the remaining network addresses includes the network address associated with a geographic region.

In yet another embodiment, a server computer system comprises a storage area containing a network address locator data structure comprising metatags associated with network addresses; wherein the metatags contain geographic region information defining regions. An application residing on the server computer system is configured to search the network address locator data structure for a network address associated with a region in response to receiving a query containing geographic location information indicative of a current location of a requesting device.

In still another embodiment, a data structure is stored on a signal bearing medium and is accessible by a search tool to resolve a query containing geographic information indicative of a requesting device's current position. The data structure comprises metatags associated with network addresses, wherein each metatag contains geographic region information defining at least one region associated with at least one network address.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a schematic diagram of a networked environment comprising client devices and servers.

FIG. 2 is an exemplary data structure associating network addresses with geographic location information.

FIG. 3 is one embodiment of a graphical user interface configured for user input to initiate a search for a network address based on geographic location information.

FIG. 4 is another embodiment of a graphical user interface configured for user input to initiate a search for a network address based on geographic location information.

FIG. 5 is an embodiment of an interface adaptable to client devices and configured to initiate a search for a network address based on geographic location information.

FIG. 6 is a flow chart illustrating the operation of a client device when preparing and submitting a search for a network address based on geographic location information.

FIG. 7 is a flow chart illustrating the operation of a server computer when processing a search for a network address based on geographic location information.

FIG. 8 is a layout of a strip mall.

### DETAILED DESCRIPTION OF THE PREFERRED EMBODIMENTS

Methods, systems and articles of manufacture for searching network information by geographic region are provided. A geographic region may be defined as the metes and bounds of a plot of land, an area identified by a physical address or a particular structure, a global positioning system (GPS) address, etc. In each case, a geographic region is associated with a network address, such as a uniform resource locator (URL). The association between the network address and the region may be embodied in a data structure. An application then uses the data structure to resolve a query containing geographic location information indicating a current position of a requesting device.

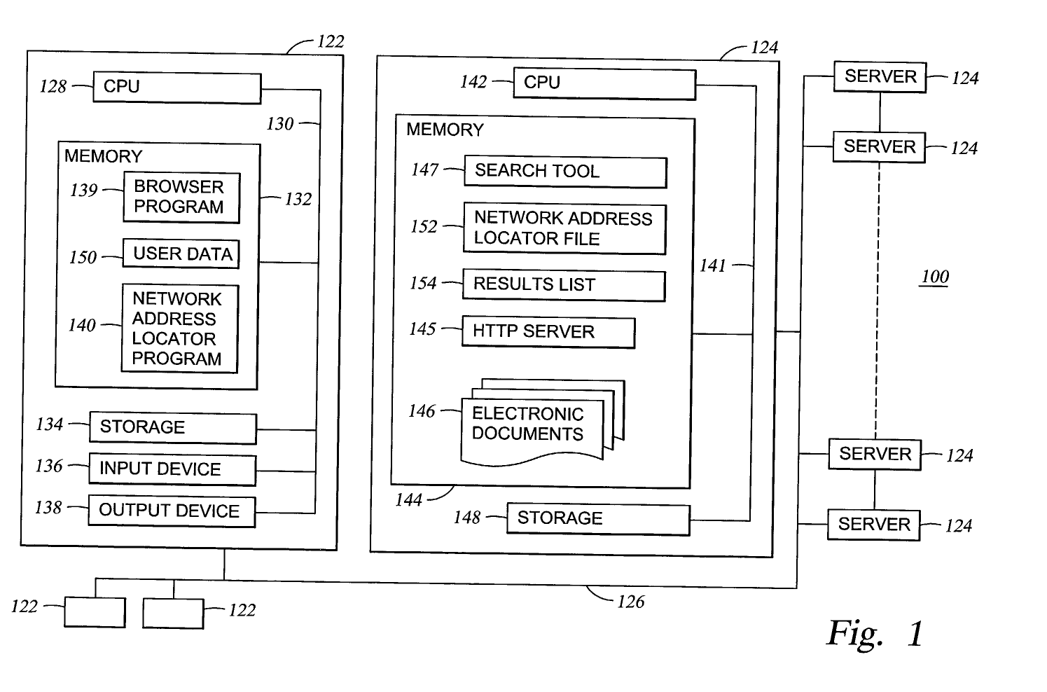

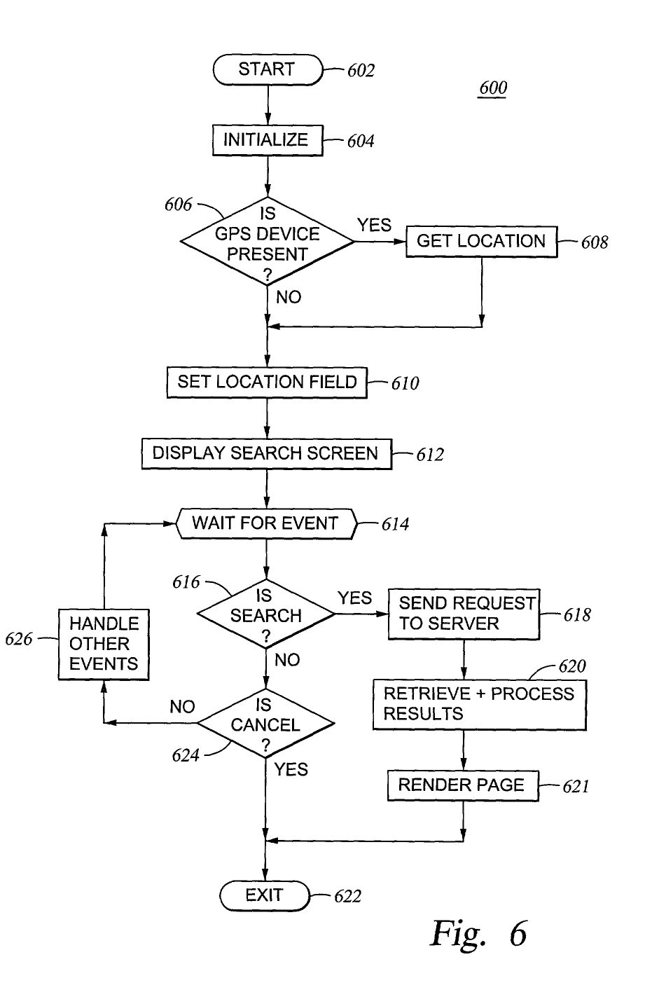

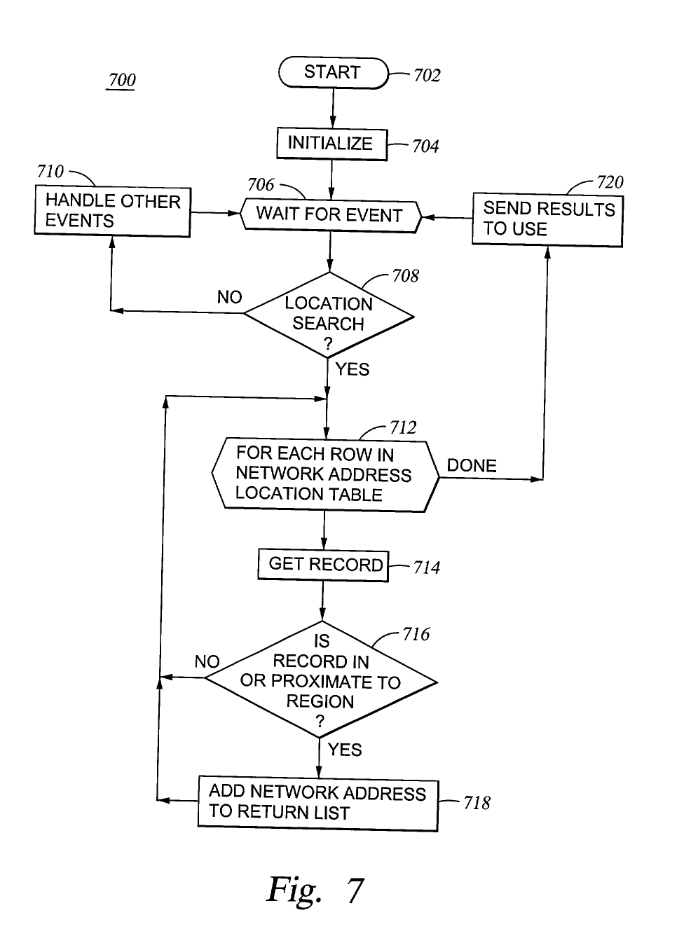

One embodiment of the invention is implemented as a program product for use with a computer system such as, for example, the network environment shown in FIG. 1 and described below. The program(s) of the program product defines functions of the embodiments (including the methods described below with reference to FIGS. 6-7) and can be contained on a variety of signal/bearing media. Illustrative signal/bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, whether implemented as part of an operating system or a specific application, component, program, module, object, or sequence of instructions may be referred to herein as a “program”. The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

FIG. 1 depicts one embodiment of a data processing system 100. In general, the data processing system 100 includes a client (e.g. user's) computer 122 and at least one server 124 (five such servers 124 are shown). The client computer 122 and the server computers 124 may be the components of the same computer system, or may be connected via a network 126, such as the Internet. In particular, the server computers 124 may be components of the Internet or other wide area network (WAN) or local area network (LAN).

In general, the client computers 122 may be desktop computers, personal digital assistants (PDAs), wireless telephones, laptops and the like. Illustratively, the client computer 122 includes a Central Processing Unit (CPU) 128 connected via a bus 130 to a memory 132, storage 134, input device 136, and output device 138. The input device 136 can be any device to give input to the client computer 122. For example, a keyboard, keypad, light-pen, touch-screen, track-ball, or speech recognition unit could be used. In one embodiment, the input device 136 is a global positioning system (GPS) or other external device or computer used to determine the physical location of the user's computer. The output device 138 is preferably any conventional display screen and, although shown separately from the input device 136, the output device 138 and input device 136 could be combined. For example, a display screen with an integrated touch-screen, and a display with an integrated keyboard, or a speech recognition unit combined with a text speech converter could be used. Storage 134 is preferably a direct access storage device (DASD), although it is shown as a single unit, it could be a combination of fixed and/or removable storage devices, such as fixed disc drives, floppy disc drives, tape drives, removable memory cards, or optical storage. Memory 132 and storage 134 could be part of one virtual address space spanning multiple primary and secondary storage devices.

Memory 132 is preferably random access memory sufficiently large to hold the necessary programming and data structures located on the client computer 122. While memory 132 is shown as a single entity, it should be understood that memory 132 may in fact comprise a plurality of modules, and that memory 132 may exist at multiple levels, from high speed registers and caches to lower speed but larger DRAM chips. Memory 132 contains a network address locator program 140 that, when executed on CPU 128, provides support locating network addresses at one or more of the servers 124. In the illustrative embodiment, a browser program 139 is provided. Browsers are well known and are configured for navigating the network 126 and between the various servers 124. Exemplary browsers that may be used to advantage include Internet Explorer and Netscape. In operation, the network address locator program 140 and the browser 139 may work in tandem or separately. Although shown separately in FIG. 1, in another embodiment, the network address locator program 140 is a component of the browser 139.

Memory 132 also contains a user information data structure 150 comprising user specific information such as preferences and configuration information usable by the network address locator program 140. In a particular embodiment, the user configuration data structure 150 includes cookies to facilitate communication with previously visited network locations.

Each server computer 124 generally comprises a CPU 142, a memory 144, and a storage device 148, coupled to one another by a bus 141. Memory 144 is a random access memory sufficiently large to hold the necessary programming and data structures that are located on the server computer 124. The programming and data structures may be accessed and executed by the CPU 142 as needed during operation. In a particular embodiment, the server 124 is a Web server. Accordingly, the memory 144 includes a hypertext transfer protocol (http) server process 145 adapted to service requests from the client computer 122. For example, process 145 may respond to requests to access electronic resource(s) 146 (e.g., HTML documents, network information, and the like) residing on the server 124. The http server process 145 is merely illustrative and other embodiments adapted to support any known and unknown protocols are contemplated.

In one embodiment, a network search tool 147 resides within memory 144. When executed on CPU 142 in response to receipt of a search query, the network search tool 147 searches its own storage, the network 126 and/or the system of servers 124 for information pertaining to the query. The results generated are then sent to the requesting client computer 122. In one embodiment, the network search tool 147 is specifically configured for performing searches in response to receiving a geographic location/region request. In another embodiment, the network search tool 147 is a multi-purpose search tool (e.g., search engine or directory) that has been configured to support geographic location/region requests according to the inventive methods set forth herein.

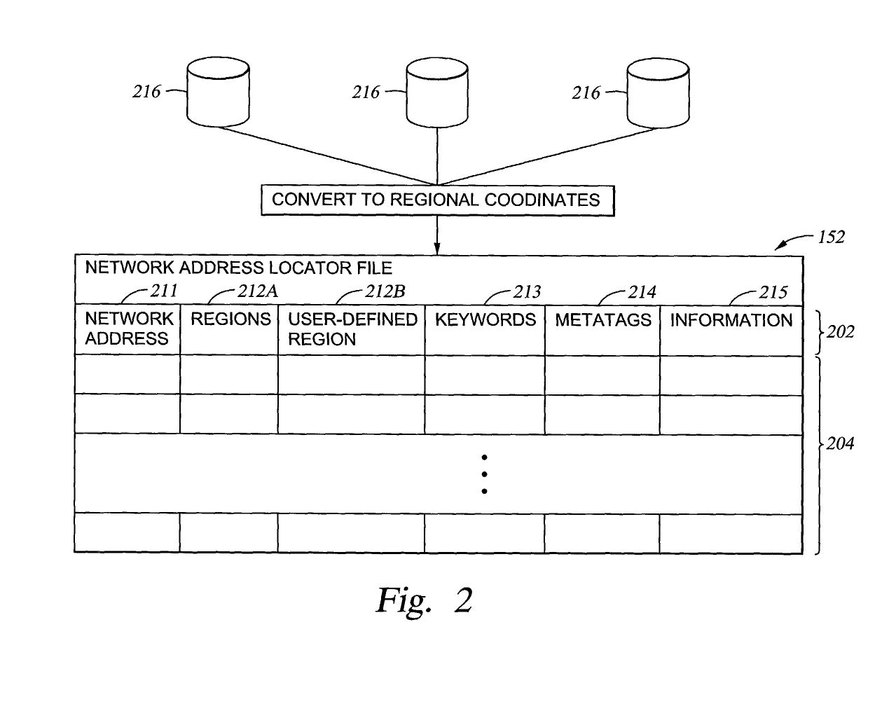

The geographic location/region requests may be satisfied by reference to any number of data structures which may reside on the server 124 on which the network search tool 147 resides or elsewhere. In the event the data structures are local, they may be accessed, for example, by the hypertext transfer protocol (http) server process 145 and/or the network search tool 147. Illustrative data structures include a network address locator file 152 and any results list 154, both shown in memory 144. In general, the network address locator file 152 contains a plurality of network addresses (e.g., URLs) and associated search information. The search information is data that can be mapped to or otherwise associated with the network addresses such that queries containing the search information may be resolved into one or more network addresses by the search tool 147. An embodiment of the network address locator file 152 is described below with reference to FIG. 2. The results list 152 is a buffer or other memory area for storing the results of a search performed by the search tool 147 and which will be transmitted to a requesting client device 122.

FIG. 1 is merely one configuration for data processing system 100. Embodiments of the invention can apply to any comparable configuration, regardless of whether the system includes complicated multi-user computing apparatus, single-user workstations, or network appliances that do not have non-volatile storage of its own.

FIG. 2 shows one embodiment of the network address locator file 152. The network address locator file 152 is organized as a column 202 and a plurality of rows 204. The columns 202 designate a particular category of information while each row 204 comprises a record of the network address locator file 152. In one embodiment, the network address locator file 152 is an index compiled by a spider or robot.

The columns 202 of the network address locator file 152 include a network address column 211, a location column 212A, a user-specified location column 212B, a keywords column 213, a metatags column 214 and an information column 215. Illustratively, the entries under the network address column 211 may be URLs, i.e., the HTTP protocol text used to render a web page. The data contained under the location column 212A contains regional information defining a region that associated with a particular network address. In one embodiment, the positional information is a geographic region, or regions, defined by distinct GPS points. The region may be defined by any combination of any longitudinal coordinate, a latitudinal coordinate and an altitudinal coordinate. In another embodiment, the area associated with a plat layout (a land survey describing the metes and bounds of a piece of property) may define the positional information. In any event, the information may be retrieved from a variety of repositories 216. For example, public land records repositories provide a convenient source of location information. The appropriate land record may be located using well-known descriptors, such as a street address, zip code, a reel and frame number and the like. The location information may then be converted into a set of coordinates or other positional information defining a region. For example, given a mailing address, a region can be defined for the physical property or land at the location of the mailing address.

The provision of the user-defined location column 212B gives users the flexibility to define their own regions. For example, consider a stadium having a plurality of surrounding parking lots, each managed by different proprietors. Using a user's current GPS coordinates, a geographic region query in which the location column 212A was accessed, would only return the URL for the parking lot in which the user is located. However, the user may in fact be interested in all of the stadium parking lots. Accordingly, the user may define the region of interest to include all of the surrounding area around the stadium. The user may also add additional search terms to the query to ensure that a response only includes URLs for parking lots.

The keywords column 213 and metatags column 214 contain information used by conventional search tools, as is well known in the art. In one embodiment, the information contained under the metatags column 214 may include a specialized HTML tag defined to represent the geographical region that is associated with a network address. The following illustrates a possible syntax for such a tag:

<meta geographic region=X₁, X₂, . . . X_{N}Y₁, Y₂, . . . Y_{N} . . . ,> where the values X_{N} and Y_{N} represent regional information for two distinct regions.

Thus, the illustrative tag comprises a geographic location name attribute (“geographic region”) and an associated content attribute (“X₁, X₂, . . . X_{N}. . . ”) containing the geographic location information. The values for the associated content attribute are retrieved from the location columns 212A-B. It should be noted that the associated content attribute may comprise more than one region. In the present example two regions are specified, region X_{N} and region Y_{N}. The provision of multiple regions in a single metatag addresses situations in which a single website is associated with multiple regions. For example, consider the situation in which a business manages a plurality of retail stores. In this case, the business may host a single website containing information for each of its retail stores.

The information column 215 is provided to indicate that the network address locator file 152 may include any number of additional columns used by the search tool 147 to return network addresses in response to a query.

It is understood that the network address locator file 152 is merely illustrative. In other embodiments the data shown in the network address locator file 152 may stored over more than one data structure. In particular, the network address locator file 152 may contain pointers (or other references) to the data rather than the data itself. For example, the information in the location columns 212A-B may comprise pointers to the geographic region information, which may be contained elsewhere in the network address locator file 152 or in a completely separate data structure. In any case, an association between the geographic region information and the associated network address and/or between the metatags and the geographic region information may be maintained.

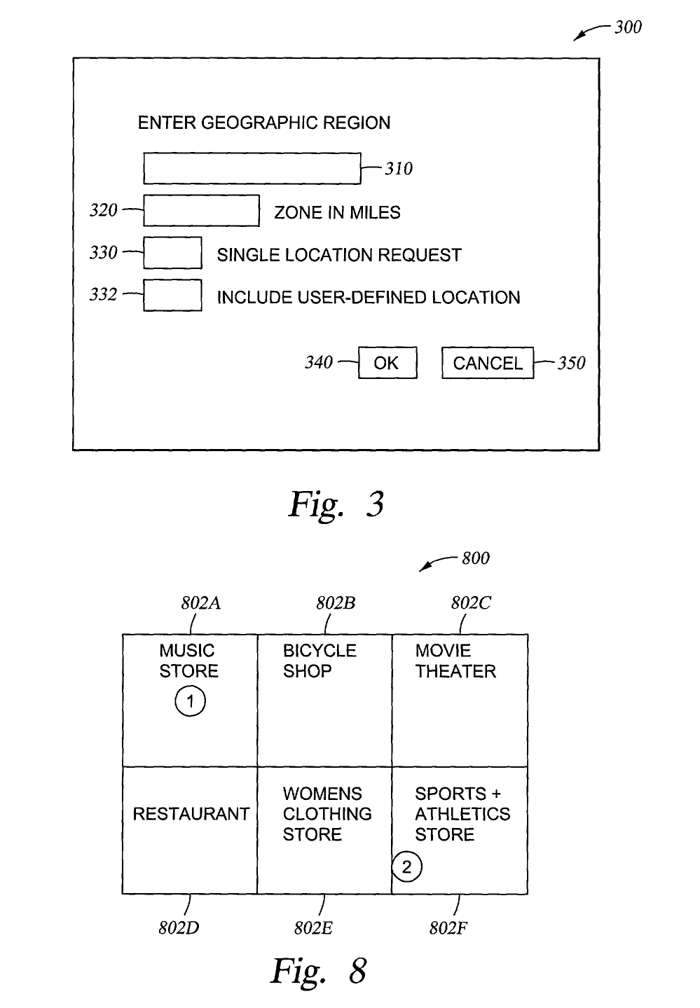

FIG. 3 depicts one embodiment of a GUI 300. In general, the GUI 300 may be configured with fields, check boxes, pulldown menus, radio buttons, hyper-links and other features facilitating the efforts of the user interested in locating a network address according to geographic information. The GUI 300 may be invoked by the network address locator program 140 and/or the browser program 152 in response to a user command. Illustratively, the GUI 300 includes a location field 310 and a zone field 320. The location field 310 allows a user to enter a particular geographic location (e.g., a street address or GPS position) while the zone field 320 allows the user to specify a region around the particular geographic location. For example, the zone field 320 may be configured for entry of a radius. In the illustrated embodiment, the GUI 300 also includes a “single location requests” checkbox 330. When selected, the results returned for a query will be restricted to a single network address for the specified positional information. If the checkbox 330 is not selected, multiple network addresses may be returned. The GUI 300 also includes a “include user-defined location” checkbox 332. When checkbox 332 is selected, a search will include user-defined regions contained in the user-defined region column 212B. To submit a request, a user clicks on the OK button 340. To cancel a submission, the user may click on the CANCEL button 350.

The GUI 300 shown in FIG. 3 is merely illustrative. In another embodiment, the GUI 300 displays on map in which a user may point, click and/or draw the region of interest. In still another embodiment, the GUI 300 may be configured with a drop-down menu consisting of a selection of geographical regions/locations. These menu options may be preloaded, downloaded or configured by a user.

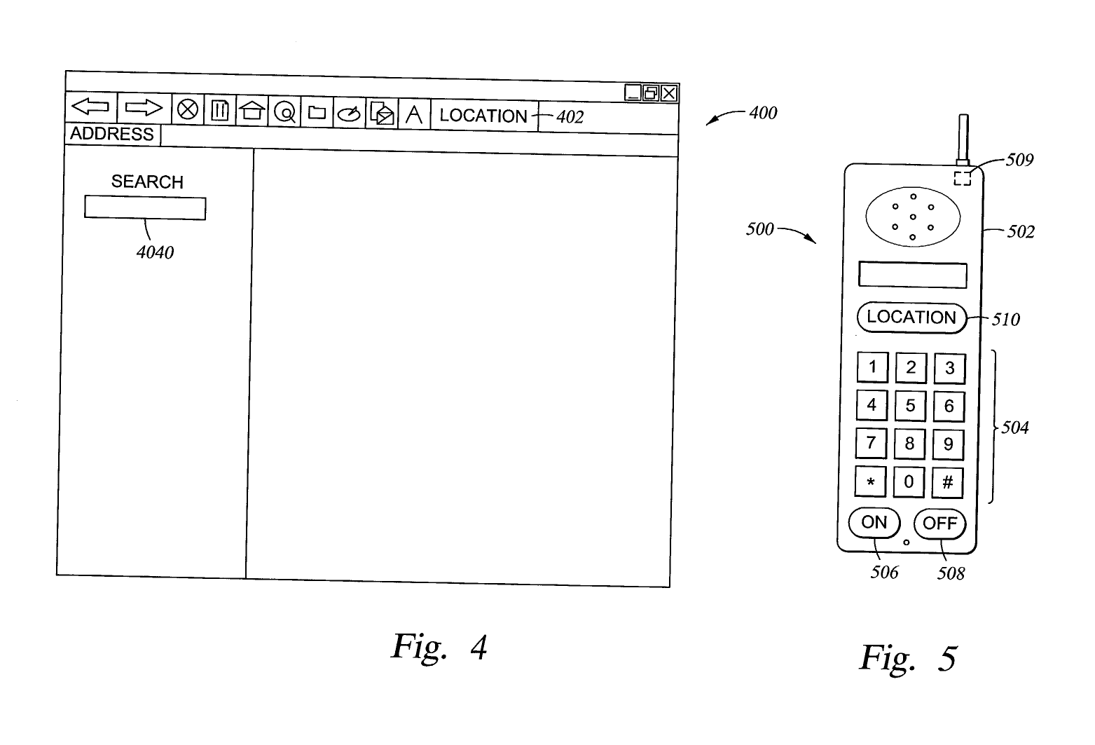

For embodiments in which the network address locator program 140 is a standalone program, the GUI 300 may be a default screen displayed upon activation of the client device 122. However, as described above, network address locator program 140 may be a component of the browser 152. In this case, the browser 152 may be configured with additional features supporting a search by geographic location/region according to the methods provided herein. For example, browser windows may be configured with a user-selectable checkbox or menu option which, when selected, activates a specialized mode allowing for searches by geographic region. The specialized mode ensures that the receiving machine (i.e., the server 124) recognizes the search as a geographic region search. One such embodiment is illustrated with reference to a browser window 400 in FIG. 4. In general, the browser window 400 may be configured with fields, check boxes, pulldown menus, radio buttons, hyper-links and other features facilitating the efforts of the user interested in locating a network address according to geographic information. In addition to conventional features, the browser window 400 has been modified with a location button 402. When clicked, the location button 402 activates the specialized geographic location search mode. The user may then input a desired search query (e.g., into the search field 404). In particular, the user enters a location defined by, for example, GPS coordinates for the user's current location. In one embodiment, when such a specialized mode is enabled, the user is provided with the GUI 300. In any of the foregoing embodiments, the appropriate GUI may be provided to a user automatically, without requiring a specified input from the user. In addition, the user's current coordinates are preferably automatically input (e.g., into the search field 404).

FIG. 5 shows another embodiment of an interface 502 which may be used to advantage. Illustratively, the interface 502 is a component of a mobile telephone 500 (which is an embodiment of the client device 122). The interface 502 generally includes a keypad 504, a power button 506 and an OFF button 508. In one embodiment, any single button or combination of the buttons may be overloaded to allow an immediate retrieval of a network address based on the current position of the mobile telephone 500. The current position may be provided, for example, by a GPS unit 509 residing on the mobile telephone 500. In another embodiment, the telephone 500 is configured with a LOCATION button 510 which, when pressed, retrieves the desired network address. It is understood that the mobile telephone 500 is representative of any handheld device (e.g., PDA) that may be used to advantage.

FIG. 6 shows one embodiment of a method 600 illustrating steps that may be taken by a client device 122 in order to locate network addresses according to geographic information. In one embodiment, the method 600 may be understood as the execution of the network address locator program 140. The method 600 is entered a step 602 and proceeds to step 604 for initialization. Initialization may include tasks such as reading data from previous executions of the network address locator program 140 and reading default values for the program 140, such as a default location, zone distance and request type. At step 606 the method 600 queries whether a GPS device is present. If so, the current position of the requesting client device 122 is retrieved at step 608. The method 600 and proceeds to step 610. The method 600 also proceeds to step 610 if step 606 is answered negatively.

At step 610 a location value is set to indicate the current position of the requesting client device 122. In the event a location value was retrieved at step 608, the value is set, for example, into the location field 310 of the GUI 300 for subsequent display to the user. If no location value was retrieved at step 608, then no value is set at step 610. The GUI 300, or other user interface, is then displayed to the user at step 612. The user may change or provide the location value as necessary. At step 614, the method 600 then enters a standby mode to wait for an event.

Once an event is received at step 614, the method 600 proceeds to step 616 and queries whether the event is the submission of a query (e.g., in response to clicking the OK button 340). If so, the query is transmitted to the appropriate server 124 via the network 126 at step 618. At step 620, the results are retrieved from the server and processed at the client device 122. Processing at step 620 may include resolving ambiguities between multiple URLs. Such processing will be described below with reference to FIG. 8. At step 621, an output page is rendered on the output device 138. The method 600 then exits at step 622.

Returning to step 616, if the event is not a query submission, the method 600 proceeds to step 624. At step 624, the method queries whether the event is to cancel a query (e.g. by clicking the CANCEL button 350). If so, the method 600 exits at step 622. If not, the method 600 proceeds to step 626 to handle the event according to predefined rules. Illustrative events handled at step 626 include minimizing or maximizing a window, pressing a help button and the like. The method then returns to step 614 to wait on another event. Alternatively, the method 600 may exit (e.g., if the event at step 626 is an exit command).

As noted above, processing at step 621 may include resolve ambiguities between multiple URLs. Resolving ambiguities may be necessary because the user has specified that only one URL should be returned. Multiple URLs may be returned in some cases because, for example, the user may be standing on a boundary of two regions. Additionally or alternatively, the GPS unit 509 may be limited to resolving a location to within some margin of error, resulting in the inclusion of two or more regions. Another source of potential ambiguity occurs when two work more regions occupy a common space. In any case, resolution between multiple URLs is accomplished, for example, by accessing user preferences contained in the user data 150 and is illustrated with reference to FIG. 8.

FIG. 8 shows a layout of a strip mall 800. The strip mall 800 includes a plurality of retail stores and restaurants 802A-F. Client devices (such as mobile telephone 500) operated by users are depicted as circled numerals, 1-2. In particular, a first client device (represented by numeral 1) is located in a music store 802A and a second client device (represented by numeral 2) is located in a sports and athletics store 802F.

As illustrated, the first client device is located in a central portion of the music store 802A. As a result, retrieval of the URL of the music store 802A should be possible without ambiguity with respect to the other neighboring stores (i.e., the bicycle shop 802B and the restaurant 802D and the women's clothing store 802E).

In contrast, the second client device is proximate the border of the sports and athletics store 802F and the women's clothing store 802E. As a result, a request for a URL based on the current location of the second client device may result in a response containing the URLs for both the women's clothing store 802E and the sports and athletics store 802F. Where the user has indicated an interest in only a single URL, reference is made to the user data 150 to resolve the ambiguity. For example, the user data 150 may include a list of the user's interests. If the specified interests include sports and not women's clothing, then the URL for the women's clothing store 802E will be discarded and only the URL for the sports and athletics store 802F will be displayed. In another embodiment, the user's interests are compiled using historical information. Specifically, the client device may bookmark all URLs returned with a search and record which URL and a user selects from the multiplicity of possible URLs. In this manner, the client device may learn a user's interests and apply this knowledge to resolve future ambiguities between the same or similar URLs.

As noted above, another ambiguity between URLs may arise when two regions occupy a common space. With reference to FIG. 8, for example, the strip mall 800 defines one region while the individual stores 802 define subregions. In this case, any ambiguity may be resolved by returning only the URL for the smallest region. Alternatively, all the URLs of the regions and subregions may be ranked and displayed. In another embodiment, the client device may display a map indicating the relative positions of the regions and may also display each associated URL within the appropriate region. The user's relative position on the map may also be indicated. Using a stylus or other device, the user may select the desired URL.

FIG. 7 shows a method 700 for responding to network address requests received from a client device 122. Illustratively, the method 700 may be understood as the steps taken by the search tool 147 when executed. The method 700 is entered at step 702 and proceeds to step 704 for initialization. Initialization includes, for example, paging files into memory for performance and setting up data structures to keep track of statistical information. Following the initialization, the method 700 proceeds to step 706 to wait for an event. Once an event is received and parsed, the method 700 proceeds to step 708 and queries whether the event is a geographic location search. If not, the method 700 proceeds to step 710 to handle the event according to predefined rules. Illustrative events handled at step 710 include performing a conventional search and returning any results to the requesting device.

If the event received at step 706 is a geographic location search, then the method 700 proceeds from step 708 to step 712. At step 712, the method 700 enters a loop for each row/record 204 in the network address locator file 152. A record, if any, is retrieved at step 714. At step 716, a determination is made as to whether the record satisfies the location/region parameters provided by the client device 122 (i.e., the user input information provided to the GUI 300). Specifically, a determination is made as to whether the user is in or proximate to the region defined in the record being processed. This may be done by determining that at least one point defined by the geographic location information (provided by the client device) is contained within the geographic region of the record. If step 716 is answered negatively, the method 700 returns to step 712. Otherwise, the method 700 proceeds to step 718 where the network address of the record being processed (i.e. the information contained in the network address column 211) is added to the results list 154. The method 700 then returns to step 712. Steps 714-718 define a loop which is repeated for each row 202 of the network address locator file 152. Once each row 202 has been read, the method 700 proceeds to step 720 where the results are provided to the requesting client device 122. The method 700 then returns to step 706 to wait on another event.

While the foregoing is directed to embodiments of the present invention, other and further embodiments of the invention may be devised without departing from the basic scope thereof, and the scope thereof is determined by the claims that follow.

What is claimed is:

1. A method of locating network addresses according to geographic information, comprising:
receiving a query for a network address associated with a geographic region, wherein the query contains geographic location information indicating a current position of requesting device;
parsing the query; and
locating, in a network address locator data structure, geographic region information defining the geographic region and satisfying the query according to the geographic location information; and
returning at least the network address associated with the geographic region.

2. The method of claim 1, wherein locating comprises matching the geographic region information to geographic location information.

3. The method of claim 2, wherein matching comprises determining that at least one point defined by the geographic location information is contained within the geographic region.

4. The method of claim 1, wherein the network address locator data structure is a searchable index compiled by at least one spider.

5. The method of claim 1, wherein locating comprising accessing user-defined region information containing at least one region defined by a user issuing the query.

6. The method of claim 1, wherein the network address locator data structure comprises a plurality of network address entries and associated geographic region entries.

7. The method of claim 1, wherein the geographic location information comprises global positioning system (GPS) coordinates.

8. The method of claim 7, wherein the GPS coordinates comprise a longitudinal coordinate, a latitudinal coordinate and an altitudinal coordinate.

9. The method of claim 7, wherein the GPS coordinates comprise at least three points.

10. The method of claim 1, wherein the query contains search information indicating to a search tool a geographic region search mode.

11. The method of claim 1, wherein the query contains search information indicating to a search tool a geographic location search mode and wherein locating the geographic region comprises accessing a geographic region entry of the network address locator data structure.

12. The method of claim 1, wherein searching for the network addresses comprises processing metatag information retrieved from geographic location metatags contained in Web pages, wherein the geographic location metatags comprise a geographic location name attribute and an associated content attribute containing the geographic region information.

13. The method of claim 12, wherein the geographic location metatags contain geographic region information for a plurality of regions.

14. A method of locating network addresses according to geographic information, comprising:
receiving a query for a network address associated with a geographic region, wherein the query contains geographic location information indicating a current position of requesting device;
parsing the query; and
locating, in a network address locator data structure, geographic region information defining the geographic region and satisfying the query according to the geographic location information; and
returning at least the network address associated with the geographic region.

15. The method of claim 14, wherein the query contains search information indicating to a search tool a geographic region search mode.

16. The method of claim 14, wherein the network address locator data structure is a searchable index compiled by at least one spider.

17. The method of claim 14, wherein locating comprising accessing user-defined region information containing at least one region defined by a user issuing the query.

18. The method of claim 14, wherein the network address locator data structure comprises a plurality of network address entries and associated geographic region entries.

19. The method of claim 14, wherein the geographic location information comprises global positioning system (GPS) coordinates.

20. The method of claim 19, wherein the GPS coordinates comprise a longitudinal coordinate, a latitudinal coordinate and an altitudinal coordinate.

21. The method of claim 19, wherein the GPS coordinates comprise at least three points.

22. The method of claim 14, wherein locating comprises matching the geographic region information to geographic location information.

23. The method of claim 22, wherein matching comprises determining that at least one point defined by the geographic location information is contained within the geographic region.

24. A method of locating network addresses using geographic location information specifying a current location of a requesting device, comprising:
transmitting a query for a network address associated with a geographic region, wherein the query contains the geographic location information;
receiving a response containing at least two network addresses;
discarding at least one of the at least two network addresses; and
displaying remaining network addresses of the at least two network addresses, wherein the remaining network addresses include the network address associated with a geographic region.

25. The method of claim 24, wherein the query contains search information indicating to a search tool a geographic region search mode.

26. The method of claim 24, wherein the query is configured to instruct a search tool to access user-defined geographic region information.

27. The method of claim 24, wherein discarding comprises accessing user-preference information to eliminate the at least one of the at least two network addresses.

28. The method of claim 24, wherein displaying comprises displaying only the network address associated with a geographic region.

29. A server computer system, comprising:
a storage area containing a network address locator data structure comprising metatags associated with network addresses; wherein the metatags contain geographic region information defining regions; and
an application configured to search the network address locator data structure for a network address associated with a region in response to receiving a query containing geographic location information indicative of a current location of a requesting device.

30. The server computer system of claim 29, wherein the geographic region information comprises global positioning system (GPS) coordinates specifying the regions.

31. The server computer system of claim 29, wherein the network address locator data structure is a searchable index compiled by at least one spider.

32. The server computer system of claim 29, wherein the geographic location information and the geographic region information comprise global positioning system (GPS) coordinates.

33. The server computer system of claim 32, wherein the GPS coordinates comprise a longitudinal coordinate, a latitudinal coordinate and an altitudinal coordinate.

34. A data structure stored on a signal bearing medium and accessible by an application to resolve a query containing geographic information indicative of a requesting device's current position, the data structure comprising metatags associated with network addresses; wherein each metatag contains geographic region information defining at least one region associated with at least one network address.

35. The data structure of claim 34, wherein the data structure is a searchable index compiled by at least one spider.

36. The data structure of claim 34, wherein the at least one region comprises a plurality of regions.

37. The data structure of claim 34, wherein the at least one network address is a uniform resource locator.

38. The data structure of claim 34, wherein the geographic region information comprises GPS coordinates.

39. The data structure of claim 38, wherein the GPS coordinates comprise a longitudinal coordinate, a latitudinal coordinate and an altitudinal coordinate.
